(19) United States
(12) Patent Application Publication
(10) Pub. No.: US 2014/0365186 A1
(43) Pub. Date: Dec. 11, 2014

(54) SYSTEM AND METHOD FOR LOAD BALANCING FOR PARALLEL COMPUTATIONS ON STRUCTURED MULTI-BLOCK MESHES IN CFD

(71) Applicant: AIRBUS INDIA OPERATIONS PVT. LTD., Bangalore (IN)

(72) Inventor: NAYAN DUBEY, Bangalore (IN)

(73) Assignee: AIRBUS INDIA OPERATIONS PVT. LTD., Bangalore (IN)

(21) Appl. No.: 14/285,657

(22) Filed: May 23, 2014

(30) Foreign Application Priority Data
Jun. 11, 2013 (IN) 2545/CHE/2013

(51) Int. Cl. G06F 17/50

(52) U.S. Cl. CPC G06F 17/5009
USPC 703/2

(57) ABSTRACT

A system and method for performing load balancing for parallel computations on structured multi-block meshes in computational fluid dynamics (CFD) are disclosed. In one example, a numerical computing workload of each node in each block of a structured multi-block mesh is determined based on CFD properties, such as common operations, flow physics, mesh connectivity and the like. A numerical computing workload of each block is then determined based on the determined numerical computing workload of each node. Each block in the structured multi-block mesh is then assigned for numerical computing to one of a plurality of processors based on the determined numerical computing workload for load balancing.

### RELATED APPLICATION

Benefit is claimed under 35 U.S.C. 119(a)-(d) to Foreign application Serial No. 2545/CHE/2013 filed in India entitled “SYSTEM AND METHOD FOR LOAD BALANCING FOR PARALLEL COMPUTATIONS ON STRUCTURED MULTI-BLOCK MESHES IN CFD”, filed on Jun. 11, 2013, by AIRBUS INDIA OPERATIONS PVT. LTD., which is herein incorporated in its entirety by reference for all purposes.

### TECHNICAL FIELD

Embodiments of the present subject matter relate to computational fluid dynamics (CFD). More particularly, embodiments of the present subject matter relate to parallel computations on structured multi-block meshes in CFD.

### BACKGROUND

Use of computational fluid dynamics (CFD) for solving fluid dynamics problems with complex structural configurations is continuously increasing. Typically, CFD mesh generation process includes four basic steps: mesh generation, pre-processing, processing and post-processing. One approach to mesh generation includes dividing a computational domain, i.e., flow volume around the structure, into number of sub-domains or blocks based on components in the structure. A CFD solver is then applied to each block such that the blocks can exchange information at interface boundaries. The domain decomposition approach permits a single CFD code to be used for computing the flow over a wide variety of complex geometries. Typically, in such scenarios, CFD simulations are carried out using large number of processors to reduce computational time.

The next step includes setting up of a structured multi-block computation on a parallel distributed memory computing devices. Typically, this requires defining, prior to starting the computation, which blocks are assigned to each of the processors in the computing devices for parallel computation. To get the most computational efficiency, the blocks have to be assigned to the processors so that the computational work load is evenly distributed amongst the processors. This process is typically referred to as “load balancing” and is done during pre-processing stage. However, existing techniques for load balancing are based on considering only a number of elements in each block and not based on processing time needed for each element. For example, mathematical operations associated with each element in a block depends on flow physics associated in that region as well as other details of the mesh, such as workload due to common operations associated with each element of the mesh, workload due to mesh connectivity properties of the elements, and the like. Further, at each stage of CFD simulation, information is exchanged between neighboring blocks via their boundaries. This exchange of boundary information between the blocks is typically done by the mathematical interpolation of flow variables. This may lead to additional computational workload on the elements lying around block interfaces. The amount of computational workload on these elements depends on type of connectively that exist between the blocks, i.e., coincident, non-coincident and/or Chimera. By not considering computational workload due to mesh connectivity properties of each element in a block may result in poor load balancing and lower computational efficiency.

### SUMMARY

A system and method for load balancing for parallel computations on structured multi-block meshes in computational fluid dynamics (CFD) are disclosed. According to one aspect of the present subject matter, a structured multi-block mesh is generated for one or more components of a structure. Further, a numerical computing workload of each node in each block of the structured multi-block mesh is determined based on parameters, such as common operation, flow physics, mesh connectivity and the like. A numerical computing workload of each block is then determined based on the determined numerical computing workload of each node. Each block in the structured multi-block mesh is then assigned for numerical computing to one of a plurality of processors based on the determined numerical computing workload for load balancing. Furthermore, numerical computational information, of each node around interface boundaries of associated blocks of the structure, is exchanged between the plurality of processors. In addition, desired numerical computational information of the structure is extracted upon completion of CFD simulation of all blocks in the plurality of processors.

According to another aspect of the present subject matter, the system for load balancing for parallel computations on the structured multi-block meshes in the CFD includes a processor and a memory coupled to the processor. Further, the memory includes a CFD simulation tool. Furthermore, the CFD simulation tool includes a load balancing module. In one embodiment, the load balancing module includes instructions to perform the method described above.

According to yet another aspect of the present subject matter, a non-transitory computer-readable storage medium having instructions that, when executed by a computing device, causes the computing device to perform the method described above.

The system and method disclosed herein may be implemented in any means for achieving various aspects. Other features will be apparent from the accompanying drawings and from the detailed description that follow.

### BRIEF DESCRIPTION OF THE DRAWINGS

Examples of the invention will now be described in detail with reference to the accompanying drawings, in which:

FIG. 1 illustrates a flow diagram of an exemplary method for performing load balancing for parallel computations on structured multi-block meshes, according to one embodiment;

FIG. 2 illustrates a flow diagram of an exemplary method for determining weights for donor cell operations and receiver cell operations using a Chimera type mesh connectivity specific workload of a specific node in each block;

FIGS. 3A and 3B illustrate example graphs showing donor cells and receiver cells distribution for all blocks in a structured multi-block mesh, respectively, according to one embodiment;

FIG. 4 illustrates an example table for computing ranks of different combination of weights for the donor cell operations and the receiver cell operations for a test case, according to one embodiment;

FIG. 5 illustrates another table for computing normalized scores for the different combinations of weights for the donor cell operations and the receiver cell operations for various test cases, according to one embodiment;

FIG. 6 illustrates a perspective view of a block structured grid and background mesh of an aircraft, in the context of the invention;

FIG. 7 illustrates a perspective view of a mesh assembly formed after overlapping two structured multi-block meshes with a Chimera type of mesh connectivity, in the context of the invention; and

FIG. 8 illustrates a block diagram of an example computing system for performing parallel computations on the structured multi-block meshes in computational fluid dynamics (CFD), using the processes shown in FIGS. 1 and 2, according to one embodiment.

The drawings described herein are for illustration purposes only and are not intended to limit the scope of the present disclosure in any way.

### DETAILED DESCRIPTION

A system and method for load balancing for parallel computations on structured multi-block meshes in computational fluid dynamics (CFD) is disclosed. In the following detailed description of the examples of the present subject matter, references are made to the accompanying drawings that form a part hereof, and in which are shown by way of illustration specific in which the present subject matter may be practiced. These examples are described in sufficient detail to enable those skilled in the art to practice the present subject matter, and it is to be understood that other examples may be utilized and that changes may be made without departing from the scope of the present subject matter. The following detailed description is, therefore, not to be taken in a limiting sense, and the scope of the present invention is defined by the appended claims.

The terms “element”, “node” and “cell” are used interchangeably throughout the document. Also, the terms, “computational workload and the “numerical computing workload” are used interchangeably throughout the document. The term “numerical computing workload” refers to numerical computation time required for each node in a structural multi-block mesh. Further, the term “donor cells” herein refers to boundary cells of a block that provides solution for interpolation by providing computational information from a donor grid point to a receiver grid point. Furthermore, the term the “receiver cells” herein refers to boundary cells of the block that provides solution for the interpolation by receiving computational information from the donor grid point to the receiver grid point. Depending on whether a grid point is the donor grid point or the receiver grid point and/or based on type of connectivity, such as coincident, non-coincident and/or Chimera, certain additional specific mathematical operations for interpolation is associated with such grid points. The distribution of the donor cells and the receiver cells varies from block to block and hence the numerical computing workload associated with different blocks can change depending on distribution of the donor and the receiver cells.

It is generally known that additional computation workload exists for each block of the structured multi-block mesh due to the need for exchange of boundary information between neighboring blocks. Typically, the amount of computational workload depends on the type of connectivity between the blocks, i.e., coincident, non-coincident and/or Chimera. This additional computational workload for a block is referred as “Wblock mesh connectivity” and is generally not taken into account in existing workload models. In the present invention, a work load model is proposed that takes into account the additional computational workload involved due to the mesh connectivity. This improves the accuracy in computational workload estimates associated with each block and thereby leading to an efficient load balancing. A novel process is also proposed to compute unknown coefficients (weights) of the workload model.

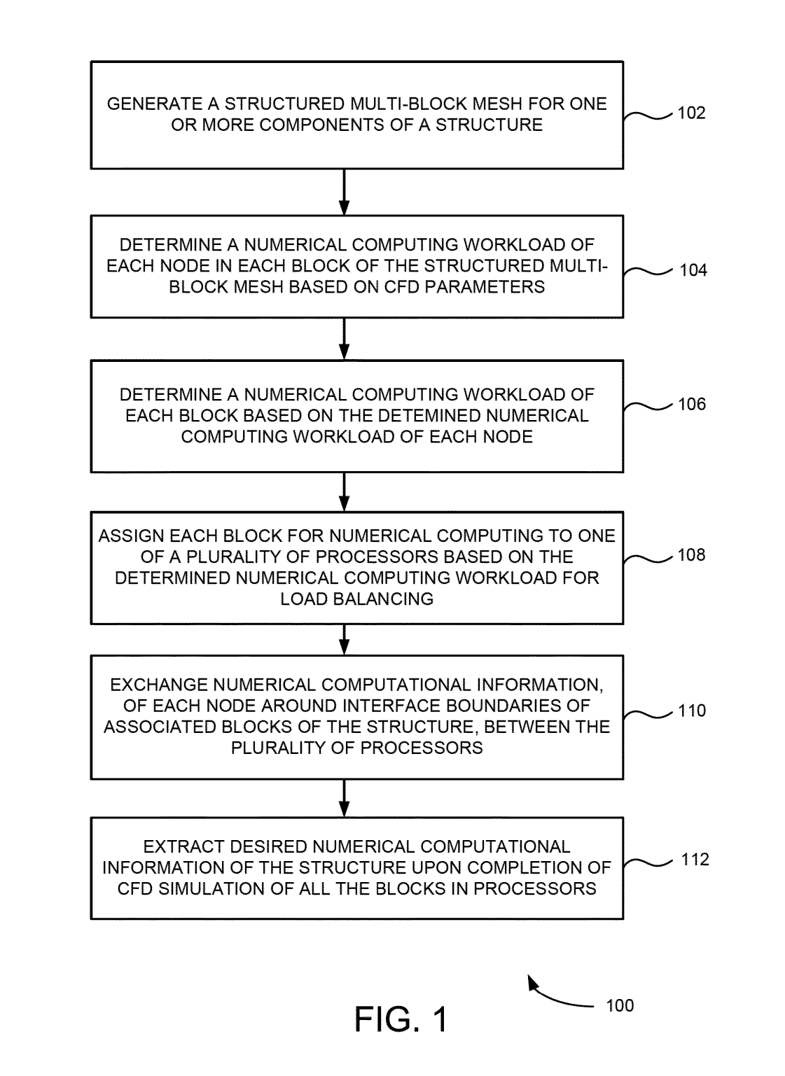

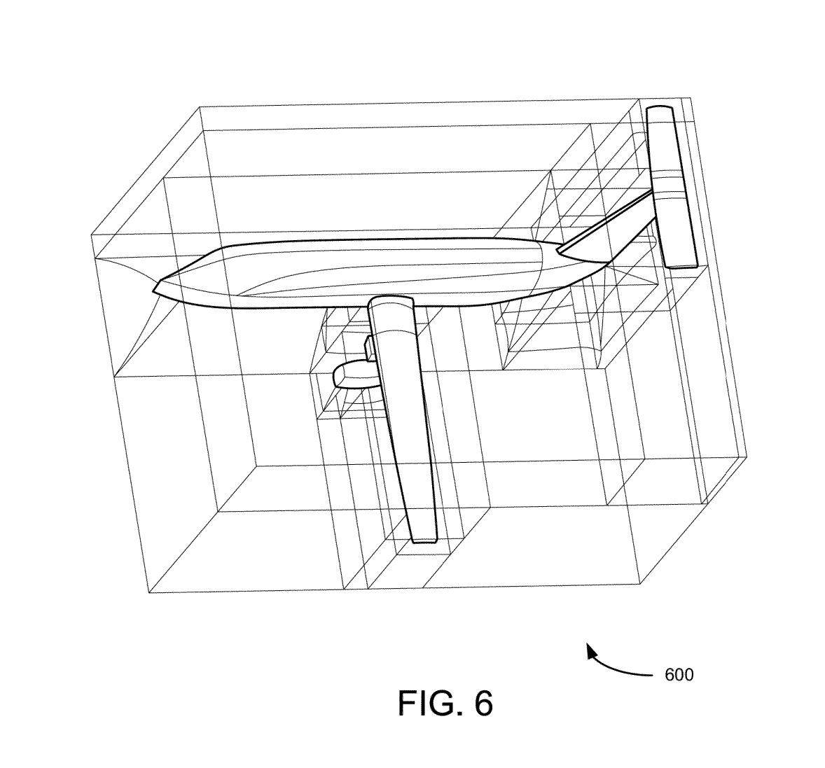

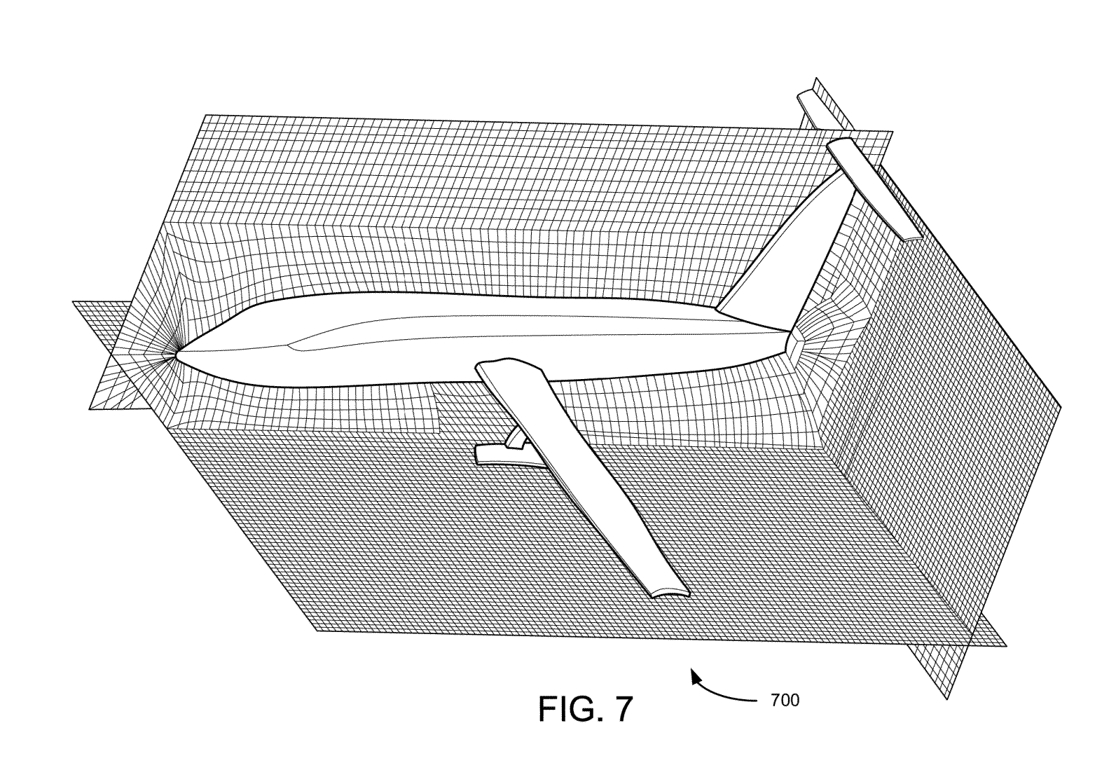

FIG. 1 illustrates a flow diagram 100 of an exemplary method for performing load balancing for parallel computations on structured multi-block meshes, according to an embodiment. At block 102, a structured multi-block mesh (shown in FIG. 7) is generated for one or more components of a structure (shown in FIG. 6). In one embodiment, the mesh is generated using block-structured grids. In this embodiment, the computational domain (3D volume) is broken down into a number of sub-domains or blocks (shown in FIG. 7). The CFD solver is applied to each block, and the blocks exchange the information with each other at the block interface boundaries. This domain decomposition approach permits a single CFD code to be used for computing the flow over a wide variety of complex geometries.

At step 104, a numerical computing workload of each node in each block of a structured multi-block mesh is determined based on CFD properties. Exemplary CFD properties are common operation, flow physics, mesh connectivity and the like. The CFD properties include common operations, such as common workload associated with all the nodes of the structured multi-block mesh, flow physics i.e., flow physics specific workload associated with specific node, and mesh connectivity i.e., mesh connectivity specific workload associated with specific node. These CFD properties can have a significant impact on the numerical computing workload for each node in each block. For example, cells existing near walls of a structure may need to perform more computation when compared to other cells that are not near the walls of the structure. In such case, there can be additional amount of numerical computing workload on the cells near the walls due to the flow physics. Further, if two neighboring components/blocks in a structure need to be stitched together the boundary cells of the neighboring components/blocks have to exchange mesh connectivity information with each other. Thus, the processing time of the boundary cells can increase due to the additional numerical computational workload resulting from the mesh connectivity specific workload associated with each of the boundary cells.

In one embodiment, the numerical computing workload of each node in each block is modeled using an equation:

Wᵢ=Wᵢ^{common operations}+Wᵢ^{flow physics}+Wᵢ^{mesh connectivity}

wherein, Wᵢ^{common operations} is common workload of all nodes of the structured multi-block mesh, Wᵢ^{flow physics} is flow physics specific workload of a specific node, and Wᵢ^{mesh connectivity} is mesh connectivity specific workload of the specific node.

At block 106, a numerical computing workload of each block is determined based on the determined numerical computing workload of each node. In one example embodiment, the numerical computing workload is determined using an equation:

$$\begin{matrix}{W}_{block} = {\sum }_{i = 1}^{T} {W}_{i} \\ = {\sum }_{i = 1}^{T} {W}_{i}^{common operations} + {\sum }_{i = 1}^{T} {W}_{i}^{flow physics} + \\ {\sum }_{i = 1}^{T} {W}_{i}^{mesh connectivity} \\ = {W}_{block}^{common operations} + {W}_{block }^{flow physics} + {W}_{block}^{mesh connectivity}\end{matrix}$$

wherein, W_{block} is the numerical computing workload of each block, Wᵢ is the numerical is the computing workload of each node in each block, and T is a total number of nodes in the block in x, y, and z directions.

From the above equations, it can be is seen that the numerical computing workload of a block includes the numerical computing workload due to common operations associated with each and every node of the mesh, numerical computing workload due to flow physics, and numerical computing workload due to mesh connectivity properties of its nodes.

It is to be noted that at each stage of the numerical computation, information is exchanged between neighbouring blocks through the boundaries. This exchange of boundary information between the blocks is done by mathematical interpolation of the flow variables. This may lead to additional numerical computing workload on the nodes lying on the blocks located at interface boundaries. The amount of the numerical computing workload on these nodes depends on the type of connectivity between the blocks, i.e., coincident, non-coincident or Chimera. This additional numerical computing workload on nodes is represented as Wᵢ^{mesh connectivity} (for the block as W_{block}^{mesh connectivity}) and if not taken into account can result in inhomogeneous distribution of mesh connectivity workload across different nodes and hence across different blocks as well. For example, in Chimera meshes, the Chimera pre-processing operations and the data interpolation procedures create a significant additional numerical computing workload that may not affect all the mesh blocks in the same way. The above technique takes into account the additional numerical computing workload coming from the mesh connectivity in the boundary interface regions.

In one embodiment, the numerical computing workload associated with mesh connectivity of each block in the structured multi-block mesh is modeled using the equation:

W_{block}^{meshconnectivity}=w_{donor}·N_{donor}+w_{receiver}·N_{receiver}

wherein, w_{block}^{mesh connectivity} is additional workload due to the mesh connectivity, w_{donor} is a weight for donor cell operations, N_{door} is a number of donor cells in each block, w_{receiver} is a weight for receiver cell operations, and N_{receiver} is a number of receiver cells in each block.

In these embodiments, the weights for the donor cell operations and the receiver cell operations, using a Chimera type mesh connectivity, of each node in each block is defined using the equations:

$${w}_{donor} = \frac{\begin{matrix}computational resource required by donor \\ cell for Chimera specific computations\end{matrix}}{\begin{matrix}computational resource required \\ by a cell for common operations\end{matrix}}$$

$$and$$

$${w}_{receiver} = \frac{\begin{matrix}computational resource required by receiver \\ cell for Chimera specific computations\end{matrix}}{\begin{matrix}computational resource required \\ by a cell for common operations\end{matrix}}$$

wherein, w_{donor} is the weight for the donor cell operations and w_{receiver} is the weight for the receiver cell operations.

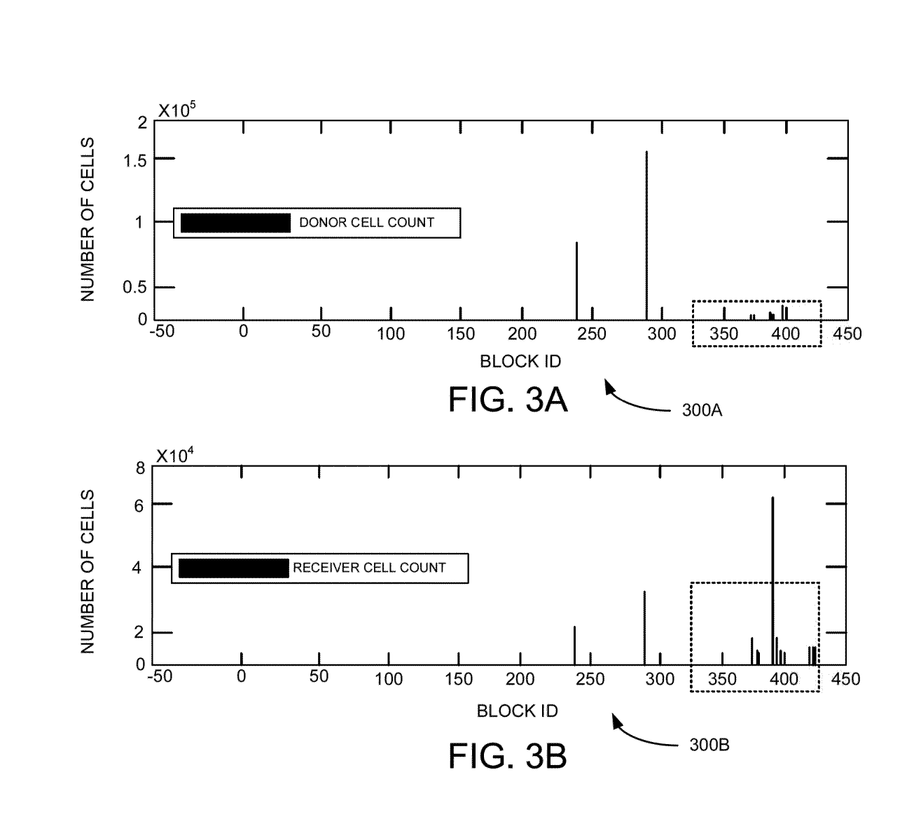

In a Chimera mesh simulation, the solution is interpolated from a ‘donor’ grid point (interface boundary) to a ‘receiver’ grid point (interface boundary). Depending on whether the grid point is the receiver or the donor grid point, certain additional specific mathematical operations for interpolation can be associated with such grid points. It is to be noted that the distribution of receiver cells and donor cells varies from block to block and hence the numerical computing workload associated with different blocks can change depending on distribution of the donor cells and the receiver cells. FIGS. 3A and 3B show an example distribution of the receiver cells and the donor cells for all the blocks in a structured multi-block mesh. It can be seen from these FIGS. 3A and 3B that the distribution of the receiver cells and the donor cells are random and specific to a given mesh and cannot be generalized.

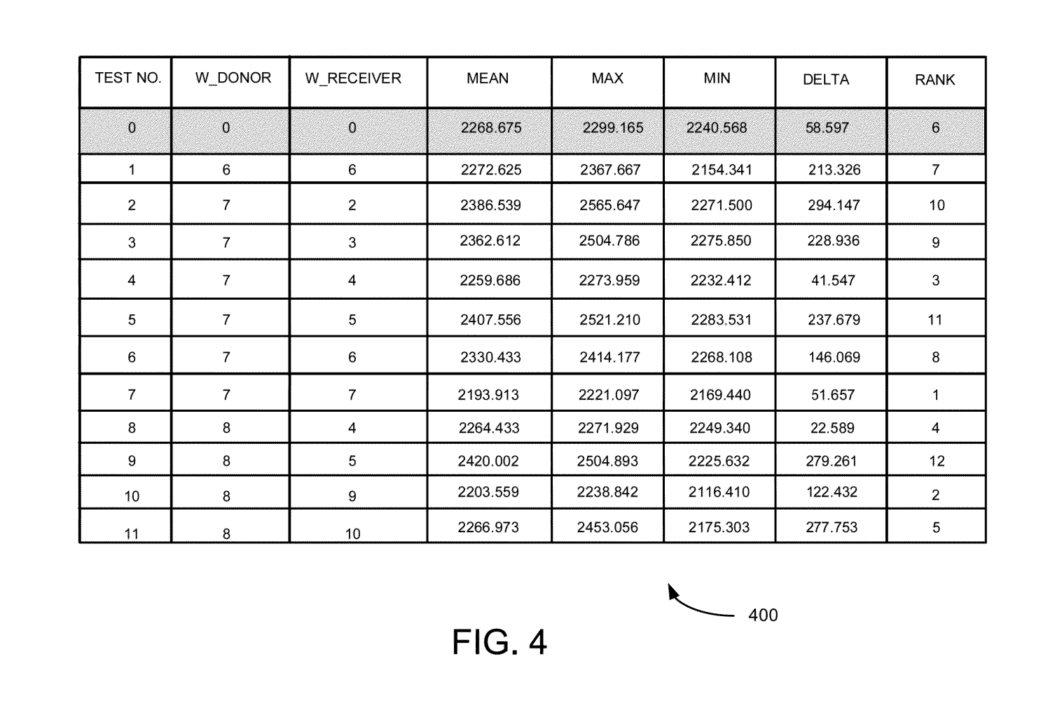

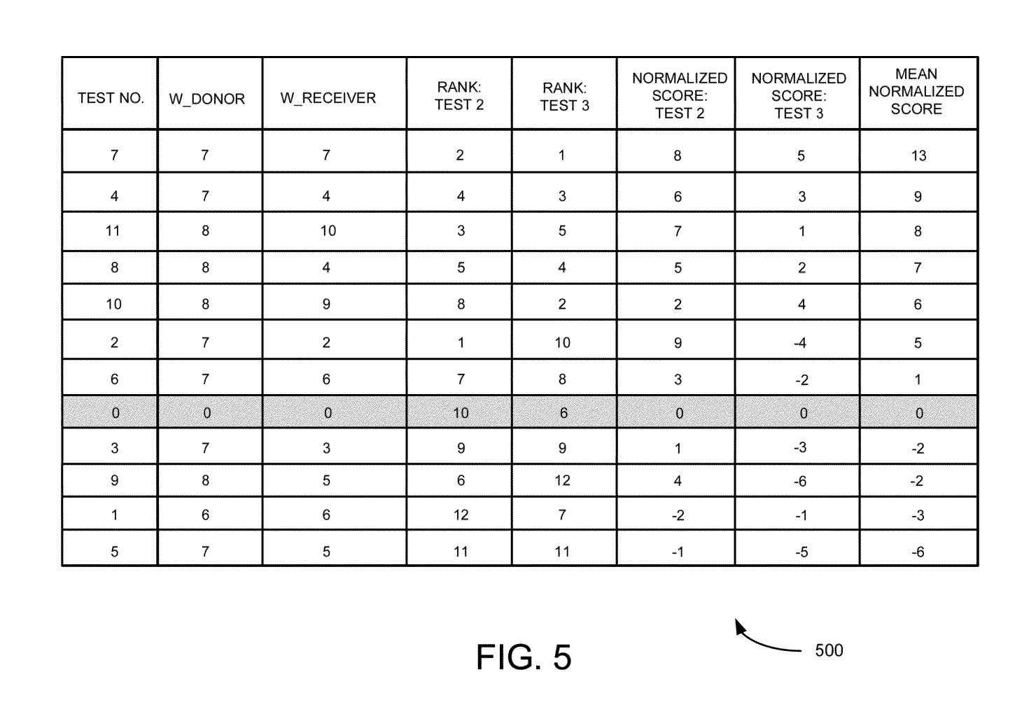

In some embodiments, the weights for the donor cell operations and receiver cell operations, using the Chimera type mesh connectivity specific workload, of each node in each block is determined by first choosing an initial set of weights for the donor cell operations and the receiver cell operations based on design of experimental techniques as shown in FIG. 4 table. An average simulation time needed is obtained by running simulations using the chosen weights for the donor cell operations and the receiver cell operations. Different weight combinations are then ranked based on their average run time (shown in FIG. 4). Such simulations tests are performed on different test cases (meshes) and finally an average rank is computed based on different test cases as shown in FIG. 5. The weight combinations having the highest rank are then chosen as optimum test case.

Theoretical computation of the weights (Wdonor, Wreceiver) can be very complex and tedious. Several techniques exist to obtain a good set of values for these weights which can reduce the time required for simulations. One technique to determine weights is described above.

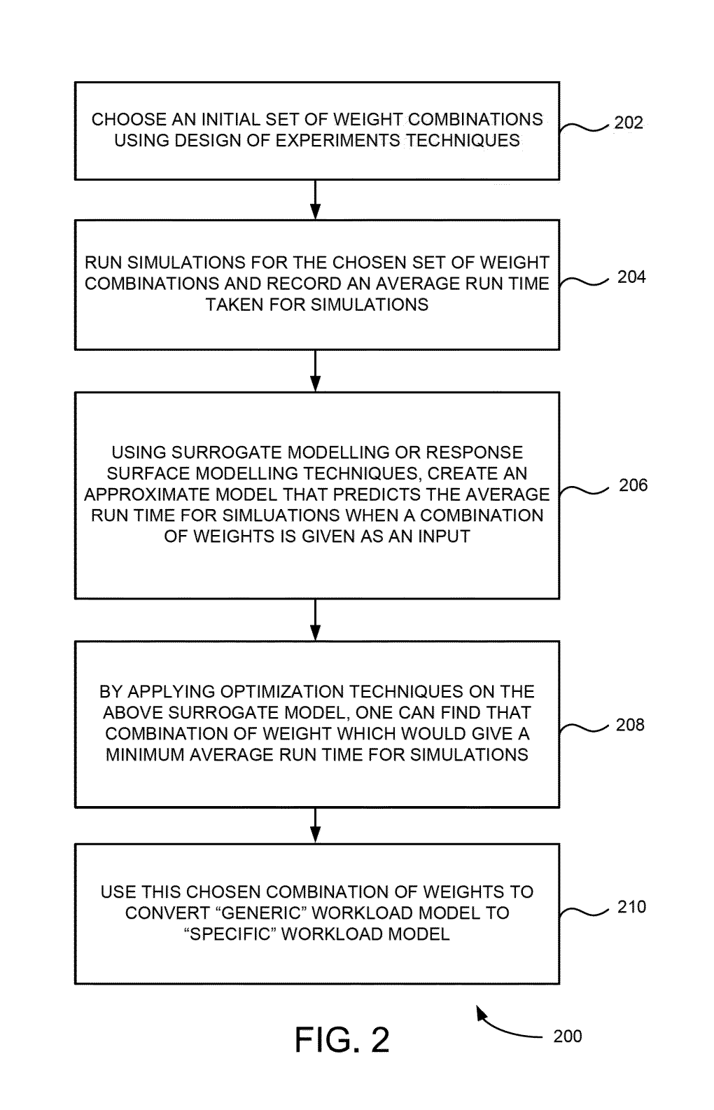

The other technique uses a combination of surrogate modeling and optimization to accurately tune the weights of generic model (Wdonor, Wreceiver). Using the well-known surrogate modeling techniques, a model relating to the two weights (Wdonor, Wreceiver) with the time taken to run simulation can be created. Subsequently, once the robustness of the model is established, standard optimization techniques may be used to find a global optimum which would be the combination of weights that lead to a minimum simulation time. It is to be noted that to create the surrogate model, initial runs have to be made for different combinations of weights. Using the data so obtained, the surrogate model can be created. To choose initial combinations of weights, prevailing techniques of “design of experiments” can be used. This process is explained in details with reference to FIG. 2 flowchart.

Although, the above mesh connectivity technique is described with reference to using a complex Chimera mesh, one can envision using the above technique with any kind of mesh connectivity.

At block 108, each block in the structured multi-block mesh is then assigned to one of a plurality of processors based on the determined numerical computing workload for load balancing to achieve substantially same numerical computing workload for each processor in a parallel computing system. This process of substantially evenly distributing the numerical computing workload among the plurality of processors is referred to as ‘load balancing’ and is generally done in the pre-processing stage of the CFD process. It is known that the overall performance of the numerical computation in terms of simulation time largely depends on the quality of such load balancing.

At block 110, numerical computation workload information of each node disposed around interface boundaries of associated blocks of the structured multi-block mesh then exchanged between the associated plurality of processors. At block 112, desired numerical computational information of the structure is extracted upon completion of CFD simulation of all the blocks in the plurality of processors.

Unlike, the process described in OD, this process is more automated and may give more accurate values of the two unknown weights. A generic flow chart for this process is shown in FIG. 1.

FIG. 2 illustrates a flow diagram of an exemplary method for automatically determining weights for donor cell operations and receiver cell operations using a Chimera type mesh connectivity specific workload of a specific node in each block.

At block 202, an initial set of weight combinations are chosen using Design of Experiments (DoE) techniques. At block 204 simulation is performed for the chosen set of weight combinations and an average run time needed to run the simulations are recorded. At block 206, an approximate model is created using surrogate modeling or response surface modeling to predict the average run time needed for simulations for a given combination of weights. At block 208, determining a combination of weights that gives a minimum average run time for the simulations by applying optimization techniques on the surrogate model. At block 210, the chosen combination of weights is chosen to convert “generic” workload model to a “specific” workload model.

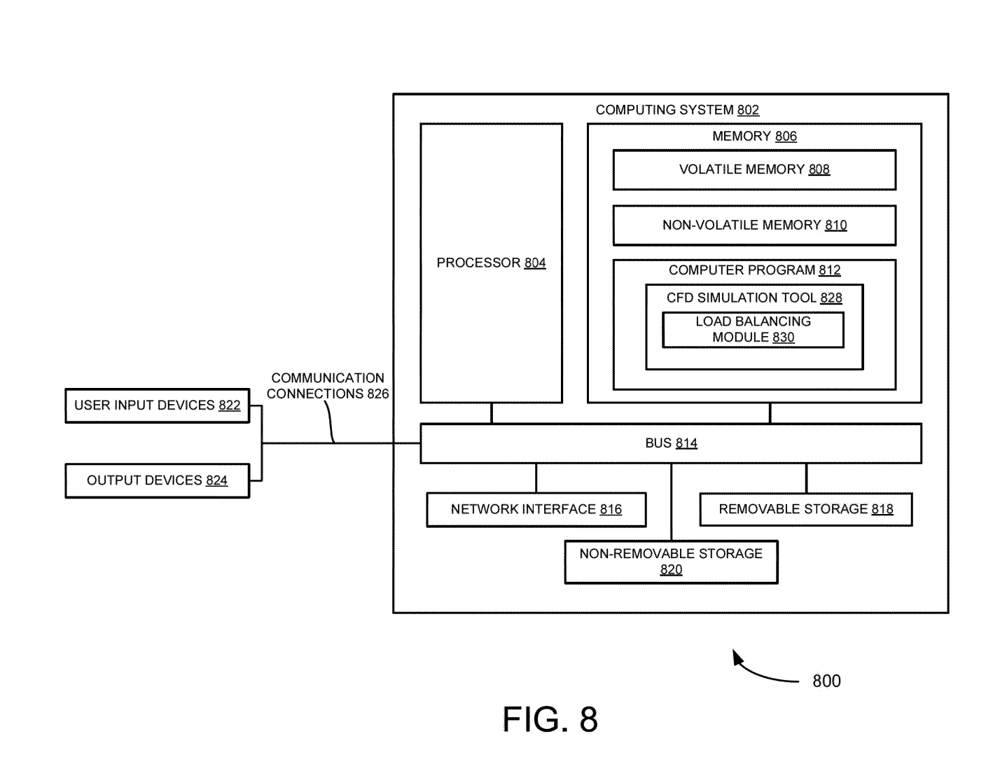

Referring now to FIG. 8, which illustrates a computing system 802 including a load balancing module 830 within a CFD simulation module 828 for load balancing for parallel computations on structured multi-block meshes in CFD, using the processes described with reference to FIGS. 1 and 2, according to one embodiment. FIG. 8 and the following discussions are intended to provide a brief, general description of a suitable computing environment in which certain embodiments of the inventive concepts contained herein are implemented.

The computing system 802 includes a processor 804, memory 806, a removable storage 818, and a non-removable storage 820. The computing system 802 additionally includes a bus 814 and a network interface 816. As shown in FIG. 8, the computing system 802 includes access to the computing system environment 800 that includes one or more user input devices 822, one or more output devices 824, and one or more communication connections 826 such as a network interface card and/or a universal serial bus connection.

Exemplary user input devices 822 include a digitizer screen, a stylus, a trackball, a keyboard, a keypad, a mouse and the like. Exemplary output devices 824 include a display unit of the personal computer, a mobile device, and the like. Exemplary communication connections 826 include a local area network, a wide area network, and/or other network.

The memory 806 further includes volatile memory 808 and non-volatile memory 810. A variety of computer-readable storage media are stored in and accessed from the memory elements of the computing system 802, such as the volatile memory 808 and the non-volatile memory 810, the removable storage 818 and the non-removable storage 820. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 804, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 804 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 804 of the computing system 802. For example, a computer program 812 includes machine-readable instructions capable of load balancing for parallel computations on structured multi-block meshes in CFD in the computing environment 800, according to the teachings and herein described embodiments of the present subject matter. In one embodiment, the computer program 812 is included on a compact disk-read only memory (CD-ROM) and loaded from the CD-ROM to a hard drive in the non-volatile memory 810. The machine-readable instructions cause the computing system 802 to encode according to the various embodiments of the present subject matter.

As shown, the computer program 812 includes the load balancing module 830 within a CFD simulation tool 828. For example, the load balancing module 830 within the CFD simulation tool 828 can be in the form of instructions stored on a non-transitory computer-readable storage medium to perform load balancing for parallel computations on structured multi-block meshes in CFD. The non-transitory computer-readable storage medium having the instructions that, when executed by the computing system 802, causes the CFD simulation system 802 to perform the methods described in FIGS. 1 and 2.

In various examples, system and method described in FIGS. 1 through 8 propose a technique to perform load balancing for parallel computations on structured multi-block meshes in CFD.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method comprising:
determining a numerical computing workload of each node in each block of a structured multi-block mesh based on computation fluid dynamics (CFD) parameters;
determining a numerical computing workload of each block based on the determined numerical computing workload of each node; and
assigning each block for numerical computing to one of a plurality of processors based on the determined numerical computing workload for load balancing.

2. The method of claim 1, wherein the CFD properties are selected from a group consisting of common operation, flow physics, and mesh connectivity.

3. The method of claim 1, further comprising:
generating the structured multi-block mesh for one or more components of a structure.

4. The method of claim 3, further comprising:
exchanging numerical computational information, of each node around interface boundaries of associated blocks of the structured multi-block mesh of the one or more components of the structure, between the associated plurality of processors; and
extracting desired numerical computational information of the structure upon completion of CFD simulation of all the blocks in the plurality of processors.

5. The method of claim 1, wherein the numerical computing workload of each node in each block is modeled using the equation:
Wᵢ=Wᵢ^{common operations}+Wᵢ^{flow physics}+Wᵢ^{mesh connectivity}
wherein, Wᵢ^{common operations} is common workload of all nodes of the structured multi-block mesh, Wᵢ^{flow physics} is flow physics specific workload of a specific node, and Wᵢ^{mesh connectivity} is mesh connectivity specific workload of the specific node.

6. The method of claim 5, wherein the numerical computing workload of each block is determined using the equation:
$$\begin{matrix}{W}_{block} = {\sum }_{i = 1}^{T} {W}_{i} \\ = {\sum }_{i = 1}^{T} {W}_{i}^{common operations} + {\sum }_{i = 1}^{T} {W}_{i}^{flow physics} + \\ {\sum }_{i = 1}^{T} {W}_{i}^{mesh connectivity} \\ = {W}_{block}^{common operations} + {W}_{block }^{flow physics} + {W}_{block}^{mesh connectivity}\end{matrix}$$
wherein, W_{block} is the numerical computing workload of each block, Wᵢ is the numerical computing workload of each node in each block, and T is a total number of nodes in the block in x, y, and z directions.

7. The method of claim 6, wherein the numerical computing workload associated with mesh connectivity of each block in the structured multi-block mesh is modeled using the equation:
W_{block}^{meshconnectivity}=w_{donor}·N_{donor}+w_{receiver}·N_{receiver}
wherein, W_{block}^{mesh connectivity} is additional workload due to the mesh connectivity, w_{donor} is a weight for donor cell operations, N_{donor} is a number of donor cells in each block, w_{receiver} is a weight for receiver cell operations, and N_{receiver} is a number of receiver cells in each block.

8. The method of claim 7, wherein the weights for the donor cell operations and receiver cell operations, using a Chimera type mesh connectivity, of each node in each block is defined using the equations:
$${w}_{donor} = \frac{\begin{matrix}computational resource required by donor \\ cell for Chimera specific computations\end{matrix}}{\begin{matrix}computational resource required \\ by a cell for common operations\end{matrix}}$$
$$and$$
$${w}_{receiver} = \frac{\begin{matrix}computational resource required by receiver \\ cell for Chimera specific computations\end{matrix}}{\begin{matrix}computational resource required \\ by a cell for common operations\end{matrix}}$$
wherein, w_{donor} is the weight for the donor cell operations and w_{receiver} is the weight for the receiver cell operations.

9. The method of claim 7, wherein determining the weights for the donor cell operations and receiver cell operations, using the Chimera type mesh connectivity specific workload, of each node in each block, comprises:
choosing an initial set of weights for the donor cell operations and the receiver cell operations based on design of experimental techniques;
obtaining an average simulation time needed by running simulations using the chosen weights for the donor cell operations and the receiver cell operations;
creating a surrogate model that predicts an average run time needed for performing simulations for a given combination of weights for the donor cell operations and the receiver cell operations;
obtaining a minimum average run time for performing simulations using optimization techniques on the created surrogate model; and
selecting the combination weights for the donor cell operations and the receiver cell operations based on the obtained minimum average run time.

10. A system comprising:
a plurality of processors; and
a memory coupled to the plurality of processors, wherein the memory includes a load balancing module to:
determine a numerical computing workload of each node in each block of a structured multi-block mesh based on CFD properties selected from a group consisting of common operation, flow physics, and mesh connectivity;
determine a numerical computing workload of each block based on the determined numerical computing workload of each node; and
assign each block for numerical computing to one of the plurality processors based on the determined numerical computing workload for load balancing.

11. The system of claim 10, wherein the load balancing module is further configured to:
generate the structured multi-block mesh for one or more components of a structure.

12. The system of claim 11, wherein the load balancing module is further configured to:
exchange numerical computational information, of each node around interface boundaries of associated blocks of the structured multi-block mesh of the one or more components of the structure, between the plurality of processors; and
extract desired numerical computational information of the structure upon completion of CFD simulation of all the blocks in the plurality of processors.

13. The system of claim 10, wherein the load balancing module models the numerical computing workload of each node in each block using an equation:
Wᵢ=Wᵢ^{common operations}+Wᵢ^{flow physics}+Wᵢ^{mesh connectivity}
wherein, Wᵢ^{common operations} is common workload of all nodes of the structured multi-block mesh, Wᵢ^{flow physics} is flow physics specific workload of a specific node, and Wᵢ^{mesh connectivity} is mesh connectivity specific workload of the specific node.

14. The system of claim 13, wherein the load balancing module determines the numerical computing workload of each block using the equation:
$$\begin{matrix}{W}_{block} = {\sum }_{i = 1}^{T} {W}_{i} \\ = {\sum }_{i = 1}^{T} {W}_{i}^{common operations} + {\sum }_{i = 1}^{T} {W}_{i}^{flow physics} + \\ {\sum }_{i = 1}^{T} {W}_{i}^{mesh connectivity} \\ = {W}_{block}^{common operations} + {W}_{block }^{flow physics} + {W}_{block}^{mesh connectivity}\end{matrix}$$
wherein, W_{block} is the numerical computing workload of each block, W₁ is the numerical computing workload of each node in each block, and T is a total number of nodes in the block in x, y, and z directions.

15. The system of claim 14, wherein the load balancing module models the numerical computing workload associated with mesh connectivity of each block in the structured multi-block using the equation:
W_{block}^{meshconnectivity}=w_{donor}·N_{donor}+w_{receiver}·N_{receiver}
wherein, W_{block}^{mesh connectivity} is additional workload due to the mesh connectivity, w_{donor} is a weight for donor cell operations, N_{donor} is a number of donor cells in each block, w_{receiver} is a weight for receiver cell operations, and N_{receiver} is a number of receiver cells in each block.

16. The system of claim 15, wherein the load balancing module defines the weights for the donor cell operations and receiver cell operations, using a Chimera type mesh connectivity, of each node in each block using the equations:
$${w}_{donor} = \frac{\begin{matrix}computational resource required by donor \\ cell for Chimera specific computations\end{matrix}}{\begin{matrix}computational resource required \\ by a cell for common operations\end{matrix}}$$
$$and$$
$${w}_{receiver} = \frac{\begin{matrix}computational resource required by receiver \\ cell for Chimera specific computations\end{matrix}}{\begin{matrix}computational resource required \\ by a cell for common operations\end{matrix}}$$
wherein, w_{donor} is the weight for the donor cell operations and w_{receiver} is the weight for the receiver cell operations.

17. The system of claim 15, wherein the load balancing module is configured to:
choose an initial set of weights for the donor cell operations and the receiver cell operations based on design of experimental techniques;
obtain an average simulation time needed by running simulations using the chosen weights for the donor cell operations and the receiver cell operations;
create a surrogate model that predicts an average run time needed for performing simulations for a given combination of weights for the donor cell operations and the receiver cell operations;
obtain a minimum average run time for performing simulations using optimization techniques on the created surrogate model; and
select the combination weights for the donor cell operations and the receiver cell operations based on the obtained minimum average run time.

18. A non-transitory computer storage medium having instructions that, when executed by a computing device, cause the computing device to:
determine a numerical computing workload of each node in each block of a structured multi-block mesh based on CFD properties selected from a group consisting of common operation, flow physics, and mesh connectivity;
determine a numerical computing workload of each block based on the determined numerical computing workload of each node; and
assign each block for numerical computing to one of a plurality processors based on the determined numerical computing workload for load balancing.

19. The non-transitory computer storage medium of claim 1, further comprising:
generating the structured multi-block mesh for one or more components of a structure.

20. The non-transitory computer storage medium of claim 19, further comprising:
exchanging numerical computational information, of each node around interface boundaries of associated blocks of the structured multi-block mesh of the one or more components of the structure, between the plurality of processors; and
extracting desired numerical computational information of the structure upon completion of CFD simulation of all the blocks in the plurality of processors.

21. The non-transitory computer storage medium of claim 18, wherein the numerical computing workload of each node in each block is modeled using the equation:
Wᵢ=Wᵢ^{common operations}+Wᵢ^{flow physics}+Wᵢ^{mesh connectivity}
wherein, Wᵢ^{common operations} is common workload of all nodes of the structured multi-block mesh, Wᵢ^{flow physics} is flow physics specific workload of a specific node, and Wᵢ^{mesh connectivity} is mesh connectivity specific workload of the specific node.

22. The non-transitory computer storage medium of claim 20, wherein the numerical computing workload of each block is determined using the equation:
$$\begin{matrix}{W}_{block} = {\sum }_{i = 1}^{T} {W}_{i} \\ = {\sum }_{i = 1}^{T} {W}_{i}^{common operations} + {\sum }_{i = 1}^{T} {W}_{i}^{flow physics} + \\ {\sum }_{i = 1}^{T} {W}_{i}^{mesh connectivity} \\ = {W}_{block}^{common operations} + {W}_{block }^{flow physics} + {W}_{block}^{mesh connectivity}\end{matrix}$$
wherein, W_{block} is the numerical computing workload of each block, Wᵢ is the numerical computing workload of each node in each block, and T is a total number of nodes in the block in x, y, and z directions.

23. The non-transitory computer storage medium of claim 21, wherein the numerical computing workload associated with mesh connectivity of each block in the structured multi-block mesh is modeled using the equation:
W_{block}^{meshconnectivity}=w_{donor}·N_{donor}+w_{receiver}·N_{receiver}
wherein, w_{block}^{mesh connectivity} is additional workload due to the mesh connectivity, w_{donor} is a weight for donor cell operations, N_{donor} is a number of donor cells in each block, w_{receiver} is a weight for receiver cell operations, and N_{receiver} is a number of receiver cells in each block.
